(19) United States
(12) Patent Application Publication
(10) Pub. No.: US 2015/0097662 A1
(43) Pub. Date: Apr. 9, 2015

(54) FLEXIBLE BOARD TYPE TIRE PRESSURE SENSOR DEVICE

(71) Applicant: CUB ELECPARTS INC., Changhua County (TW)

(72) Inventors: SAN-CHUAN YU, CHANGHUA COUNTY (TW); TZU-WEN KO, CHANGHUA CITY, CHANGHUA COUNTY (TW); TSAN-NUNG WANG, CHANGHUA COUNTY (TW); YEN-HUNG LIN, TAICHUNG CITY (TW); YU-HSIEN LIN, CHANGHUA COUNTY (TW); KUO-TING LEE, CHANGHUA COUNTY (TW)

(73) Assignee: CUB ELECPARTS INC., Changhua County (TW)

(21) Appl. No.: 14/048,807

(22) Filed: Oct. 8, 2013

(51) Int. Cl. B60C 23/04

(52) U.S. Cl. CPC B60C 23/0491
USPC 340/442

(57) ABSTRACT

A flexible board type tire pressure sensor device includes a flexible PC board having a first surface bonded to an inside wall of a tire of a vehicle wheel and a second surface opposite to the first surface, a sensor module installed in the second surface of the flexible PC board for sensing a variety of statuses of the vehicle wheel, a transmission terminal set installed in the second surface of the flexible PC board and electrically connected with the sensor module for allowing transmission of a communication program to the sensor module, and an antenna installed in the second surface of the flexible PC board and electrically connected with the sensor module for sending out a sensor signal generated by the sensor module. Thus, the flexible board type tire pressure sensor device has excellent structural stability to provide accurate sensing results.

### BACKGROUND OF THE INVENTION

1. Field of the Invention

The present invention relates to tire pressure monitoring technology, and more particularly, to a flexible board type tire pressure sensor device.

2. Description of the Related Art

Conventional tire pressure monitoring systems commonly use a tire pressure sensor device in each tire to detect tire characteristic data (tire pressure or temperature) and to transmit detected data to a processor that processes the data and provides processed data to the vehicle driver by text graphics, lighting or sound, thereby effectively improving driving safety.

During installation of a conventional tire pressure sensor device in a vehicle wheel, a fastening member (such as screw bolt or nut) is used to affix the tire pressure sensor device to the air valve. However, this fastening member can easily loosened or forced away from the vehicle wheel by a centrifugal force during high speed rotation of the vehicle wheel, losing the tire pressure sensor fixation effect. When this condition occurs, the tire pressure sensor device can easily be forced to hit the wheel rim repeatedly during high speed rotation of the vehicle wheel, causing damage.

### SUMMARY OF THE INVENTION

The present invention has been accomplished under the circumstances in view. It is the main object of the present invention to provide a flexible board type tire pressure sensor device, which enhances the structural stability in the installation in the tire, providing accurate sensing results.

To achieve this and other objects of the present invention, a flexible board type tire pressure sensor device of the present invention comprises a flexible PC board, a sensor module, a transmission terminal set and an antenna. The flexible PC board comprises a first surface and a second surface opposite to the first surface. The first surface of the flexible PC board is bonded to an inside wall of a tire of a vehicle wheel. The sensor module is installed in the second surface of the flexible PC board for sensing a variety of statuses of the tire during rotation of the vehicle wheel and then generating a corresponding sensor signal. The transmission terminal set is installed in the second surface of the flexible PC board and electrically connected with the sensor module for the connection of a setting tool for transmission of a variety of communication programs to the sensor module for storage. The antenna is installed in the second surface of the flexible PC board and electrically connected with the sensor module for sensing out a sensor signal generated by the sensor module.

Preferably, the flexible PC board comprises an adhesive layer coated on the first surface thereof for bonding to the inside wall of the tire of the vehicle wheel, and at least one vent hole cut through the first and second surfaces for exhaust of residual air between the flexible PC board and the adhesive layer during installation, achieving best adaptation between the flexible PC board and the tire.

Preferably, the flexible PC board comprises a frame mounted at the second surface around the sensor module, and an encapsulation structure molded in the frame to surround the sensor module and to provide best insulation protection to the sensor module.

Preferably, the flexible PC board comprises a plurality of protrusions equally spaced around the periphery thereof to increase the contact area between the flexible PC board and the inside wall of the tire of the vehicle wheel, enhancing the structural stability after installation.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique top elevational view of a flexible board type tire pressure sensor device in accordance with a first embodiment of the present invention before molding of an encapsulation structure.

FIG. 2 is an oblique top elevational view of the flexible board type tire pressure sensor device in accordance with the first embodiment of the present invention.

FIG. 3 is a schematic sectional view of the first embodiment of the present invention, illustrating the flexible board type tire pressure sensor device bonded to the inside wall of the tire.

FIG. 4 is an oblique top elevational view of a flexible board type tire pressure sensor device in accordance with a second embodiment of the present invention.

FIG. 5 is an oblique top elevational view of a flexible board type tire pressure sensor device in accordance with a third embodiment of the present invention.

### DETAILED DESCRIPTION OF THE INVENTION

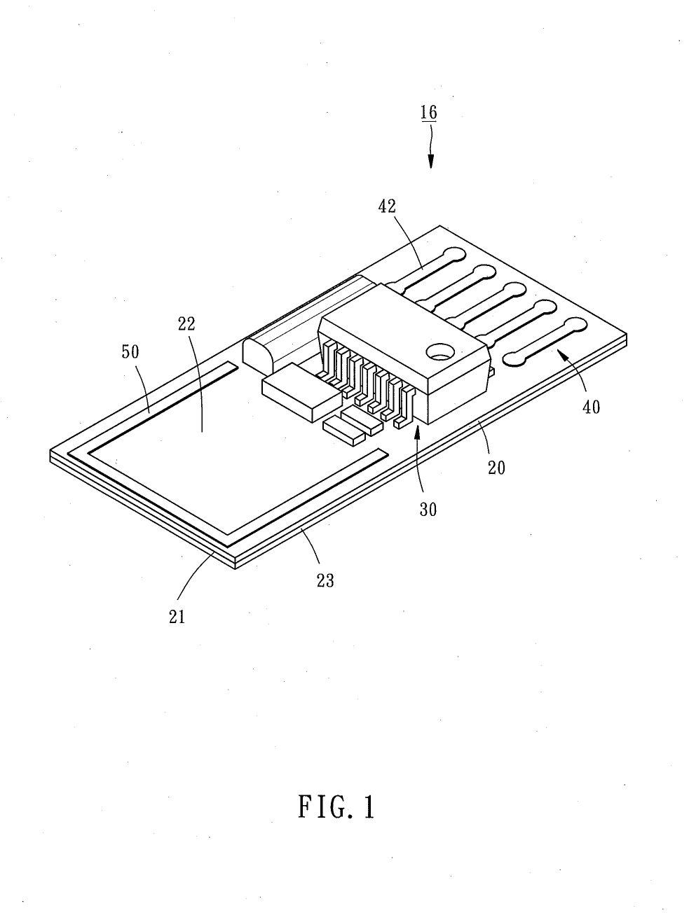

Referring to FIG. 1, a flexible board type tire pressure sensor device in accordance with the present invention is shown. The flexible board type tire pressure sensor device 16 comprises a flexible PC board 20, a sensor module 30, a transmission terminal set 40, and an antenna 50.

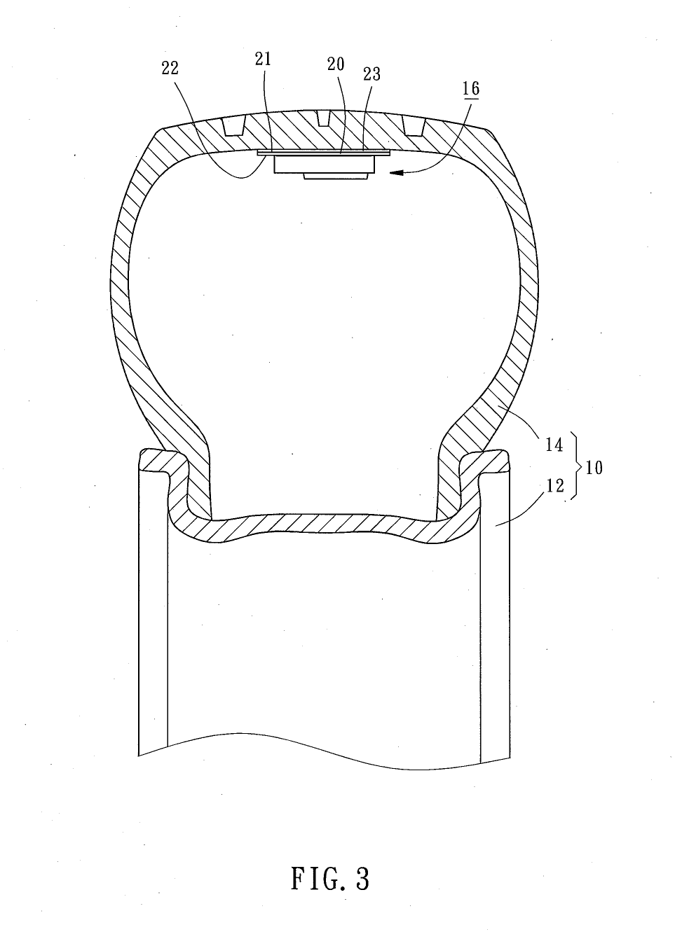

The flexible PC board 20 is a flexible copper foil substrate treated through etching and other processing processes for use as electronic signal transmission medium. The flexible PC board 20 comprises a first surface 21, a second surface 22 opposite to the first surface 21, an adhesive layer 23 coated on the first surface 21 for bonding the flexible PC board 20 to an inside wall of a tire 14 of a vehicle wheel 10, as shown in FIG. 3. After bonding, the second surface 22 of the flexible PC board 20 is kept facing toward a wheel rim 12 of the vehicle wheel 10.

The sensor module 30 is mounted at the second surface 22 of the flexible PC board 20, and adapted for sensing the internal pressure, temperature or other related information of the tire 14 and generating a corresponding sensor signal. This sensor module 30 is of the known art and not within the scope of the technical features of the present invention. In order to save space, detailed description with respect to the arrangement of the internal components of the sensor module will not be necessary.

The transmission terminal set 40 is installed in the second surface 22 of the flexible PC board 20, and electrically connected with the sensor module 30. The transmission terminal set 40 comprises 5 pcs of transmission terminals 42, wherein transmission terminals from 1^{st} to 4^{th} are respectively adapted for power control, grounding, data synchronization signal transmission, and program data transfer, and the 5^{th} transmission terminal is a spare and can be used for frequency switching and anti-error control. Thus, when transmission terminal set 40 is linked to a setting tool (not shown), a user can use the setting tool to select the communication program subject to the brand, year and model of the vehicle and then to transmit the selected communication program to the sensor module 30 for storage.

The antenna 50 is installed in the second surface 22 of the flexible PC board 20 and electrically connected with the sensor module 30, and adapted for sending out the sensor signal generated by the sensor module 30.

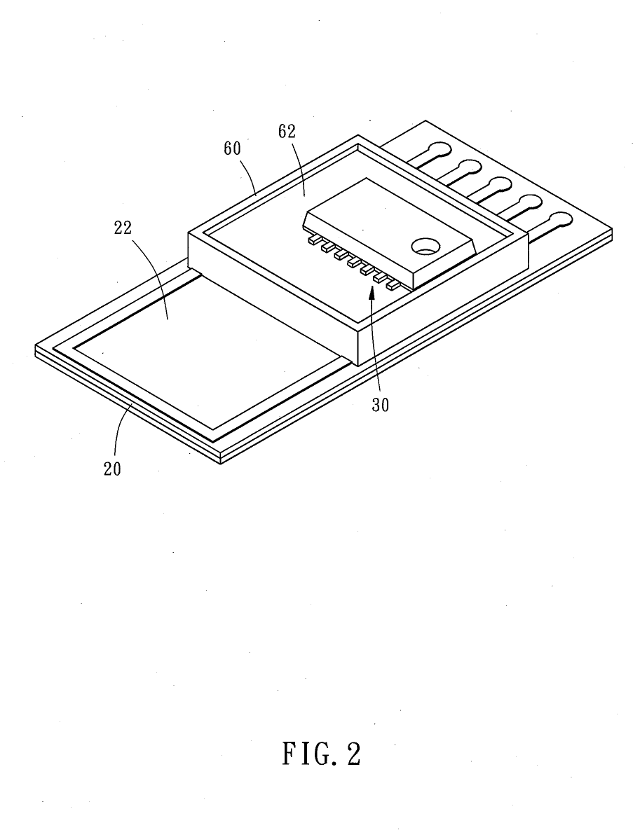

Referring also to FIG. 2, the flexible board type tire pressure sensor device 16 further comprises a frame 60 and an encapsulation structure 62. The frame 60 is mounted at the second surface 22 of the flexible PC board 20 around the sensor module 30. The encapsulation structure 62 is mounted within the frame 60 to surround the sensor module 30, providing insulation protection to the sensor module 30.

We know from the above, as shown in FIG. 3, after installation of the flexible board type tire pressure sensor device 16 in the vehicle wheel 10, the centrifugal force produced during high speed rotation of the vehicle wheel 10 can force the flexible PC board 20 to abut against the inside wall of the tire 14 of the vehicle wheel 10 more tightly. When compared to conventional tire pressure sensor devices that commonly use a fastening member for fixation, the flexible board type tire pressure sensor device 16 of the present invention has enhanced structural stability for providing a variety of tire information of accurate sensing results to the driver.

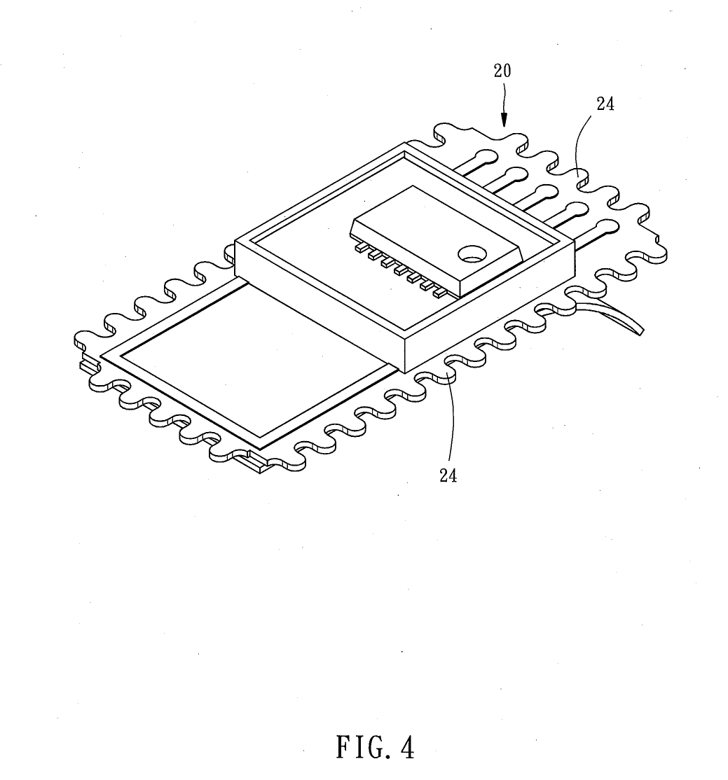

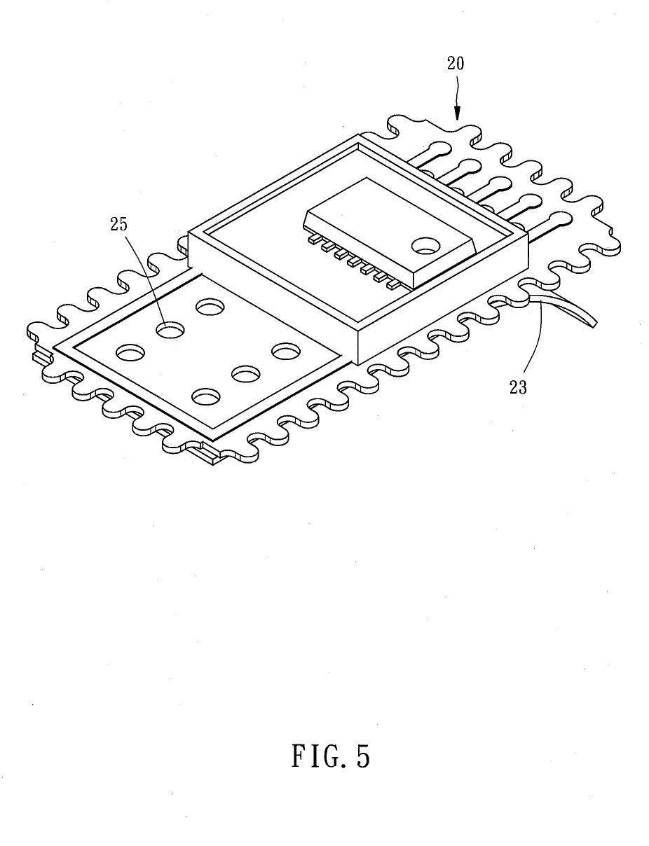

On the other hand, as shown in FIG. 4, the flexible PC board 20 can be configured to provide a plurality of equally spaced protrusions 24 of arched shape around the periphery thereof. Subject to the arrangement of the protrusions 24, the flexible PC board 20 can fit the configuration of the tire 14 of any of a variety of different vehicle wheels 10, increasing the contact area with the tire 14 and enhancing structural stability after installation. The protrusions 24 can be made in any of a variety of geometrical shapes, however, arched shape is the best. In addition to the protrusions 24, as shown in FIG. 5, the flexible PC board 20 can be made to provide a plurality of vent holes 25 cut through the first surface 21 and the second surface 22. Thus, when bonding the flexible PC board 20 to the inside wall of the tire 14, residual air between the flexible PC board 20 and the tire 14 can be expelled through the vent holes 25, and thus the best adaptation between the flexible PC board 20 and the tire 14 can be achieved, enhancing overall structural stability after installation.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A flexible board type tire pressure sensor device for sensing the tire pressure of a vehicle wheel, said vehicle wheel comprising a wheel rim and a tire mounted at said wheel rim, the flexible board type tire pressure sensor device comprising:
a flexible PC board comprising a first surface and a second surface opposite to said first surface, said first surface of said flexible PC board being adapted for bonding to said tire of said vehicle wheel;
a sensor module installed in said second surface of said flexible PC board;
a transmission terminal set installed in said second surface of said flexible PC board and electrically connected with said sensor module; and
an antenna installed in said second surface of said flexible PC board and electrically connected with said sensor module.

2. The flexible board type tire pressure sensor device as claimed in claim 1, wherein said flexible PC board further comprises an adhesive layer coated on said first surface and adapted for bonding said flexible PC board to said tire of said vehicle wheel.

3. The flexible board type tire pressure sensor device as claimed in claim 2, wherein said flexible PC board further comprises at least one vent hole cut through said first surface and said second surface.

4. The flexible board type tire pressure sensor device as claimed in claim 1, further comprising a frame mounted at said second surface of said flexible PC board around said sensor module, and an encapsulation structure mounted within said frame to surround said sensor module.

5. The flexible board type tire pressure sensor device as claimed in claim 1, wherein said flexible PC board further comprises a plurality of protrusions equally spaced around the periphery thereof.

6. The flexible board type tire pressure sensor device as claimed in claim 5, wherein said protrusions of said flexible PC board have an arched shape.
